(19) United States
(12) Patent Application Publication
(10) Pub. No.: US 2026/0104314 A1
(43) Pub. Date: Apr. 16, 2026

(54) ARRANGEMENT FOR A SPIN TEST BENCH

(71) Applicant: Schenck RoTec GmbH, Darmstadt (DE)

(72) Inventors: Volker BINSACK, Weiterstadt (DE); Helge GRAEFENSTEIN, Bensheim (DE); Karl-Josef HOFFMANN, Darmstadt (DE)

(73) Assignee: Schenck RoTec GmbH, Darmstadt (DE)

(21) Appl. No.: 19/114,911

(22) PCT Filed: Sep. 19, 2023
(86) PCT No.: PCT/DE2023/100701

§ 371 Date: Mar. 25, 2025

(30) Foreign Application Priority Data
Sep. 29, 2022 (DE) 10 2022 125 208.6

(51) Int. Cl. G01M 13/025

(52) U.S. Cl. CPC G01M 13/025

(57) ABSTRACT

In an arrangement for a spin test bench with a shaft, that is able to be connected in a rotationally fixed manner to a drive via a bearing element, and with a clamping holder that is intended for receiving a rotor to be tested and is able to be connected in a rotationally fixed manner to the shaft, a flexible spring element is between the drive and shaft, and between the shaft and the rotor. The design compensates for bending forces acting on the shaft and/or the clamping holder caused by vibration of the rotor.

The invention refers to an arrangement for a spin test bench in which a rotor to be tested is driven in rotation on a flexible shaft.

To test their durability, rotationally symmetrical structural components are usually subjected to a test procedure that is carried out on a spin test bench, on which the test specimens are spun up to burst speed or another predefined speed. In addition, the rotor can be subjected to cyclical speed changes or temperature fluctuations, for example. Such a test bench is known from DE 1 125 206 A.

The rotor can be suspended from a thin, elastic shaft, e.g. via its shaft journal, and accelerated. The rotor then rotates around its axis of inertia instead of its geometric axis, so that the rotor moves virtually free of unbalanced forces. As the elastic natural frequencies of the shaft are usually passed through and large deflections can occur, dampers are often used to limit the shaft deflection so that the amplitudes of the centrifugal shafts can be limited.

Damping systems are known, for example, from DE 102 06 950 A1, which discloses a vertically arranged high-speed rotation test device in which the shaft is mounted on both the drive side and the component side and is connected to a damping system on the component side.

DE 10 2011 087 909 B3 describes an arrangement for a component test bench, comprising a shaft for transmitting a torque from a rotary drive to a component to be tested, wherein the shaft is rotatably mounted in a bearing on the component side and on the drive side. The bearing on the component side is connected to a damping system in a hexapod arrangement so that the vibrations generated by unbalance are damped.

Furthermore, DE 28 35 962 A discloses a separator with a vertically extending rotating shaft for a centrifugal basket. The rotation shaft is held rotatably on both sides in fixed bearings and is held under tension on the side of the centrifugal basket by means of a ring rubber spring. In this way, the resonance position of the centrifugal basket is shifted by a residual imbalance into a range that is harmless in the operating state.

DE 693 08 430 T2 discloses a centrifuge with a rotor drive shaft which is formed by a flexible shaft surrounded by a sleeve, wherein the shaft and the sleeve are non-rotatably connected to each other at one of their ends, while the other end of the flexible shaft projects beyond the other end of the sleeve and holds a head which serves to hold the rotor of the centrifuge. Means are provided for internal damping and to compensate for any axial misalignment caused by assembly errors. This dampens radial movement of the shaft relative to the rotating sleeve. However, this does not result in any external damping to the stationary housing. Furthermore, the centrifuge comprises a flexible coupling that contains tubular elements made of silicone into which pins protrude in order to connect the motor shaft of the drive to the shaft in a non-rotating manner.

A device for damping rotor vibrations is known from DE 694 04 161 T2.

In some cases, structural components to be tested, for example rotors, have to be spun at high speeds (up to around 30,000 rpm) at the end of the manufacturing process so that the individual rotor components settle together due to the centrifugal force. After this setting process, a final balancing process takes place, in which any existing imbalance in the rotor is corrected. However, if the rotors comprise an excessive imbalance even before the setting process, the imbalance can cause damage to the spin test bench. To prevent this, unbalance correction can take place before the setting process, but this does not make unbalance correction after the actual setting process superfluous.

A particular problem with structural components to be tested that comprise a high level of unbalance is that damage can occur due to stresses and forces in the shaft or the component holder. Another disadvantage of the state of the art is that rotors with high unbalance have to be balanced before the setting process, which means that several time-consuming work steps have to be carried out.

The invention is based on the task of providing a means of preventing damage to the shaft or other components, particularly in the case of high imbalances, and of eliminating the need for imbalance correction prior to the setting process.

The task is solved by the features of claim 1. Preferred embodiments are described in the dependent claims.

According to the invention, the task is solved by providing an arrangement for a spin test bench, with a shaft which can be connected to a drive in a rotationally fixed manner via a bearing element and a clamping holder which is provided to hold a rotor to be tested and can be connected to the shaft in a rotationally fixed manner, characterized in that between the drive and shaft and between the shaft and rotor there is in each case a flexurally elastic spring element which is designed in such a way that bending forces exerted on the shaft and/or clamping holder by vibration of the rotor are compensated. The design of the spring elements absorbs any forces and stresses that could lead to damage to the shaft or the clamping holder. This means that even rotors with high imbalances can be tested in the spin test bench without prior compensation and the additional step of setting the rotor components during the spin process is no longer necessary.

Another advantage of the invention is that no elaborately constructed spin test benches are necessary, as no high unbalance forces occur. Furthermore, the solution prevents vibrations from being emitted to the environment in the form of structure-borne noise by the unbalanced rotor.

The spring elements are advantageously designed in such a way that deformation of the spring elements in the direction of an acting bending force is possible. This allows bending forces acting on the shaft or the clamping holder to be absorbed and compensated for, which in particular prevents damage to the shaft or the clamping holder.

In one embodiment, it is provided that the clamping holder is adapted to be at least partially flexible. Depending on the application, it may be advantageous for the clamping holder itself to be designed at least partially as a flexurally elastic spring element. This can be realized, for example, by the clamping holder comprising a structural component that is connected to the shaft in a force-transmitting manner and has slots, recesses or similar flexurally elastic elements that absorb the bending forces acting on the shaft or the clamping holder. A similar arrangement can be provided for the bearing element, so that the bearing element is at least partially adapted to be elastic in bending and comprises slots or recesses.

Alternatively, it can be provided that a flexurally adapted spring element can be connected to the clamping holder and the bearing element. In other words, this preferred embodiment is not a structural component of the clamping holder or the bearing element, but a separate and appropriately designed structural component that comprises the desired physical properties and can be reversibly or irreversibly connected to the bearing element and the clamping holder.

Preferably, the bearing element and the clamping holder as well as the spring elements comprise connecting means that enable a structural, in particular force-transmitting connection with the spring element manufactured as a separate structural component.

The spring elements can, for example, be designed as sleeve-like elements that are mounted in a force-transmitting manner between the clamping holder and shaft or between the shaft and bearing element, wherein the sleeves are designed to be flexible or at least comprise flexible areas. This can be achieved, for example, by recesses, slots or integrated springs that absorb the bending forces acting on the shaft, clamping holder or bearing element.

In one embodiment, it is provided that the bearing element and/or the clamping holder each comprise a spring element that is connected to the shaft in a force-transmitting manner and that extends radially from the shaft axis. The spring element can, for example, be provided as a circularly adapted and, in particular, radially extending diaphragm with a central sleeve-shaped shaft bushing. In particular, the diaphragm is made of a flexible metal.

The invention also refers to a spin test bench for testing a rotor comprising an arrangement described above. The advantages and embodiments explained are to be applied analogously to the spin test bench. With the advantageous design of the spin test bench, it is possible to spin rotors with high unbalances. A spin test bench can also be referred to as a component test bench in the sense of the invention.

The invention is explained in more detail below with reference to an embodiment of the invention, which is shown in the drawing. It shows

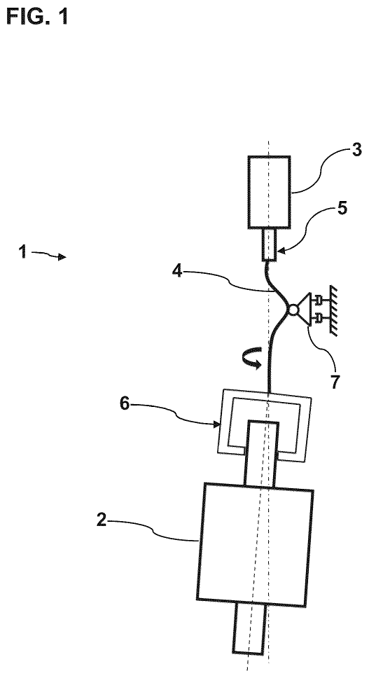

FIG. 1 a schematic representation of a spin test bench according to the state of the art,

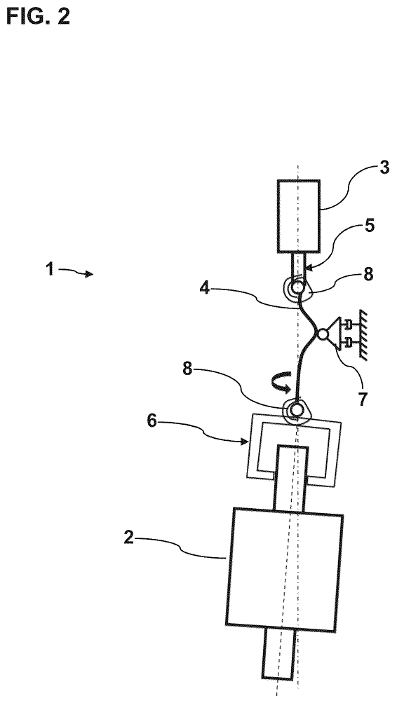

FIG. 2 an embodiment of the arrangement according to the invention in a schematic representation of a spin test bench,

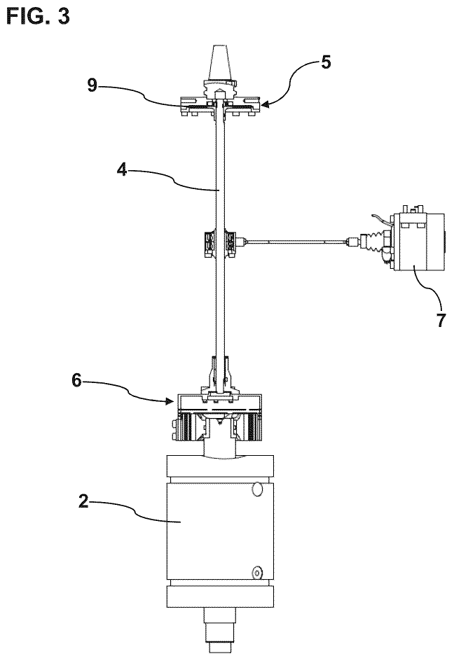

FIG. 3 a sectional view of an embodiment of the arrangement with further structural components,

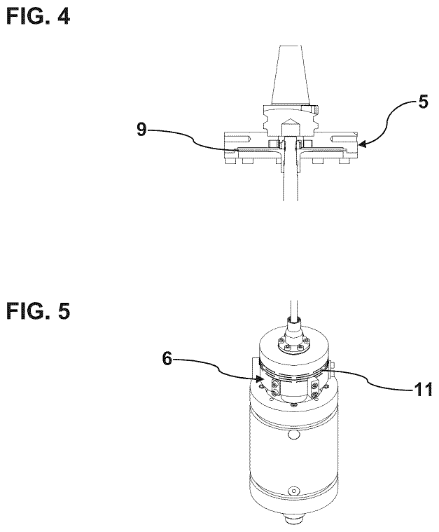

FIG. 4 a sectional view of an embodiment of a bearing element and

FIG. 5 a perspective view of a clamping holder.

FIG. 1 shows a schematic representation of a vertical spin test bench 1 according to the state of the art, with which a rotor 2 can be set in rotation as a test object in order to test its durability or the like under rotational load. In addition to an enclosure not shown, a spin test bench 1 comprises a drive 3 for supplying a torque. The drive 3 can be designed as an electric motor, for example. The torque of the drive 3 is transmitted to a vertically extending shaft 4 by connecting the shaft 4 to the drive 3 on the drive side via a torque-transmitting bearing element 5. The bearing element 5 can, for example, be adapted as a bearing, coupling or the like, in which the shaft journal of the shaft 4 engages.

The rotor-side end of the shaft 4 opposite the drive 3 is connected to the rotor 2 in a torque-transmitting manner. The rotor 2 is held in a clamping holder 6 and clamped so that it cannot rotate. The clamping holder 6 can be designed differently depending on the shape and structure of the rotor 2. An interchangeable clamping holder 6 is advantageous here, so that the clamping holder 6 can be changed depending on the test object. The clamping holder 6 can be non-rotatably connected to the shaft 4 via a flange connection.

A damping system 7 is arranged on the shaft 4 between the bearing element 5 and the clamping holder 6, which is operatively connected to the shaft 4 in a housing-fixed manner. When the rotor 2 rotates, an oscillating excitation movement to be damped is exerted on the shaft 4, which leads to vibrations of the shaft 4 in the direction of the rotation radius. These vibrations can be damped by the damping system 7.

Due to the design of the spin test bench 1, the axis of rotation of the rotor 2 to be tested is not fixed. Due to the essentially freely suspended bearing, the rotor 2 can move in such a way that it can freely choose its axis of rotation. This means that unbalanced rotors 2 rotate about their axis of inertia instead of their geometric axis, which means that essentially no unbalance forces arise. Larger imbalances can lead to damage due to stresses and forces in the shaft 4 and the clamping holder 6.

FIGS. 2 and 3 show embodiments of the invention, wherein FIGS. 4 and 5 show detailed views of the bearing element and the clamping holder. The spin test bench 1 is also shown here without an enclosure and the components are shown schematically. According to the invention, the known rotordynamic model shown in FIG. 1 is extended by two flexurally elastic spring elements 8, which are present on the drive side between drive 3 and shaft 4 and on the component side or rotor side between shaft 4 and rotor 2. The elastic spring element 8 on the drive side can be provided as a metal-designed diaphragm 9 in the bearing element 5. The diaphragm 9 can be plate-shaped and extend radially from the shaft axis. The diaphragm 9 merges into a tubular region 10, which bears against the shaft 4 axially along the shaft axis in a force-transmitting manner. The diaphragm 9 can, for example, be flange-mounted on the bearing element 5. This means that the spring element 8 can be attached to the bearing element 5 via a flange connection. Deformations resulting from a strong imbalance of the rotor 2 and transmitted from the shaft 4 to the bearing element 5 are deliberately permitted so that a low load on the bearing element 5 is achieved.

A similar or identical design can be selected between rotor 2 and shaft 4, i.e. on the rotor side. Here, the spring element 8 can also be designed as a diaphragm and attached to the clamping holder 6 via a flange connection or the like.

However, it is also possible for the spring elements 8 to be designed as a component of the bearing element 5 or the clamping holder 6. For example, the clamping holder 6 for the holder of the rotor 2 itself can be designed to be at least partially flexible and thus be provided as a spring element 8. Examples of this are recesses or slots 11 running transverse to the shaft axis, which can be integrated into the casing of the clamping holder 6, for example, and give the clamping holder 6 flexurally elastic properties. Alternatively, the clamping holder 6 can be reversibly or irreversibly connected to a spring element 8.

The spring elements 8 are advantageously connected to the shaft 4 in a structural and force-transmitting manner and absorb bending forces acting on the shaft 4. A defined stiffness of the spring elements 8 is advantageous. The use of the spring elements 8 according to the invention makes it possible, in particular, to spin rotors 2 with large imbalances without the internal stresses and forces occurring in the flexible shaft 2 and/or the clamping holder 6 reaching impermissible values and resulting in damage to them. The spring elements 8 have no damping properties. Rather, the spring elements 8 according to the invention and their positioning ensure that deformations of the rotor 2 are accommodated, as the rotor 2 aligns itself around its center of gravity axis. For this purpose, it is advantageous if the system is designed to be soft enough to achieve low loads in the bearing element 5 and the clamping holder 6.

1. An arrangement for a spin test bench (1) having a shaft (4) which can be connected in a rotationally fixed manner to a drive (3) via a bearing element (5) and a clamping holder (6) which is provided to hold a rotor (2) to be tested and can be connected in a rotationally fixed manner to the shaft (4), wherein between the drive (3) and the shaft (4) and between the shaft (4) and the rotor (2) there is in each case a flexurally elastic spring element (8) which is designed in such a way that bending forces exerted on the shaft (4) and/or the clamping holder (6) by vibration of the rotor (2) are compensated.

2. The arrangement according to claim 1, wherein an elastically adapted spring element (8) can be connected to the clamping holder (6).

3. The arrangement according to claim 1, wherein the bearing element (5) can be connected to a spring element (8) adapted to bending.

4. The arrangement according to claim 1, wherein the bearing element (5) is adapted to be at least partially elastic in bending.

5. The arrangement according to claim 1, wherein the clamping holder (6) is adapted to be at least partially flexible.

6. The arrangement according to claim 1, wherein at least one of the bearing element (5) and the clamping holder (6) comprises a spring element (8) which is connected to the shaft (4) in a force-transmitting manner and extends radially from the shaft axis and is adapted to be axially flexible.

7. The arrangement according to claim 6, wherein the spring element (8) is provided in the bearing element (5) as a circularly adapted diaphragm with a central tubular shaft feedthrough.

8. The arrangement according to claim 7, wherein the diaphragm is formed from a flexible metal.

9. The arrangement according to claim 5, wherein the flexurally elastic regions of the clamping holder (6) comprise recesses or slots (11) extending transversely to the shaft axis.

10. The arrangement according to claim 1, wherein the spring elements (8) are designed in such a way that a deformation of the spring elements (8) in the direction of an acting bending force is possible.

11. A spin test bench for testing a rotor comprising the arrangement according to claim 1.
